(19) United States
(12) Patent Application Publication
(10) Pub. No.: US 2004/0120035 A1
(43) Pub. Date: Jun. 24, 2004

(54) Binocular optical device, in particular electronic spectacles, comprising an electronic camera for automatically setting a focus that includes the correction of different vision defects

(76) Inventor: Klaus Hoffmann, Munchen (DE)

Correspondence Address: LERNER AND GREENBERG, PA, P O BOX 2480, HOLLYWOOD, FL, 33022-2480, US

(21) Appl. No.: 10/472,671

(22) PCT Filed: Feb. 12, 2002
(86) PCT No.: PCT/EP02/01454

(30) Foreign Application Priority Data
Feb. 12, 2001 (DE) 101 06 650.3

(51) Int. Cl. G02B 23/00

(52) U.S. Cl. 359/407

(57) ABSTRACT

Electronic spectacles and visual aids for various areas of application are known, in particular those also comprising microcomputers, range finders and an autofocus function. The aim of the invention is to configure a cost-effective binocular optical device in such a way that an automatic focus that includes the correction of different vision defects can be set. To achoeve this, the inventive device has a frame, at least one electronic camera that is supported by the frame and a motor-adjustable lens system that is located at the front and is connected to the electronic camera. The device is characterised in that vision defects are corrected by adjusting the refractive power of the lenses and/or by setting a focus that includes an automatic adjustment for the reading or working distance. The invention lies in the domain of electronic spectacles and visual aids.

The invention relates, as claimed in patent claim 1, primarily to a binocular optical apparatus, in particular electronic spectacles.

Spectacles, vision aids or eyeglasses for correction for eye impairments or for protection against light, dust, fragments and the like of various types have been known for a long time. Generally, vision aids such as these have lenses or prisms which are worn in front of the eyes in order to correct various visual impairments. The most widely used form of spectacles comprises a pair of glass lenses, which are held on a metal or plastic frame and are placed on the bridge of the nose. The frame is held in the correct position by side pieces, which pass around the sides of the head or are hooked in behind the ears. Spectacles with lenses made of plastic are more usual nowadays, since this material does not break as easily, and weighs less.

The human eye is a camera eye with a lens apparatus and with visual receptors which are combined to form a retina, and has a spherical structure with a diameter of about 2.5 centimeters and a significant bulge at the front. The spherical eyeball is enclosed by the white, dense sclera, which at the front is in the form of a transparent cornea. The chorioidea, which is rich in blood vessels and forms the annular iris at the boundary of the cornea, is located on the inside of the sclera. The pupil provides vision through the iris, with the pupil being reduced or increased in size by contraction or relaxing of the iris muscles, and thus ensuring that the correct amount of light always enters the eye. The retina is located on the inside of the chorioidea, is composed of the visual receptors, provides the light sensitivity, processes the light and passes it via the optic nerve to the brain. The interior of the eye is filled with the translucent vitreous body, which provides the stress and strength of the eyeball, and presses the chorioidea and retina against the base. The lens is held in place behind the iris and the pupil and can be made thicker or flattened (accommodation) by special smooth muscles (ciliary muscles). The pupil can be widened or narrowed by other muscles. The edge of the pupil rests on the front surface of the lens and separates the rear chamber of the eye, which is filled with chamber water, from the front chamber that is located between the lens, the iris and the cornea.

As already mentioned above, the method of operation of the eye is similar to that of a simple camera: the lens produces an upside down image of the outside world on the light-sensitive retina, which corresponds to the film in a camera. As already mentioned, the image is focused by flattening or thickening the lens—and this process is also referred to as accommodation. A healthy eye does not require any accommodation in order to identify objects at long distances: the lens is flattened by its holding bands and produces a sharp image of these objects on the retina. However, the closer the object being viewed, the stronger the contraction of the ciliary muscles—the holding bands relax, and the lens becomes rounder. A small child can still see clearly at a distance of about six centimeters but, with increasing age, the elasticity of the lens decreases, so that the limit for clear vision at 30 years of age is about 15 centimeters, and at 50 years of age it is about 40 centimeters. As they become older, most people lose the capability for their eyes to accommodate to the reading or working distance.

Refraction impairments lead to fuzzy visual images. These are caused by positioning impairments of the eyeball, of the cornea or of the lens, or by the internal eye muscles becoming weaker (astigmatism, hypermetropia and myopia, etc.). Refraction impairments (refraction anomalies), that is to say discrepancies from the normal light refraction in the eye with corresponding visual impairments, are: myopia, hypermetropia and astigmatism.

Myopia, which is also referred to as short-sightedness, is a defective function of the eye which is caused by lengthening of the eye axis (axis myopia) or by the refractive power of the lens being too strong (refraction myopia); in consequence, the light rays which-are refracted by the lens are focused at a point in front of the retina. At short distances, vision is still possible, but the vision in consequence becomes fuzzy at normal and long distance. Myopia is generally congenital, but often develops only at greater age. Compensation: by concave ground spectacle lenses.

Hypermetropia, which is also referred to as long-sightedness or hyperopia or in the past as far-sightedness, is a refraction impairment of the eye resulting from a misunderstanding between the refractive power of the lens and the length of the eyeball. The eyeball is either (generally) too short, that is to say axis metropia, or the refractive power is too low, that is to say refraction hypermetropia. In both cases, the (imaginary) focal point of parallel rays is actually located behind the retina, and the corresponding image is fuzzy. Hypermetropia is corrected by convex lenses. An age-dependent form of hypermetropia, which is referred to as refraction hypermetropia, is age-related vision (also referred to as presbyopia), that is to say hypermetropia which results from an age-related decrease in the accommodation capability caused by loss of elasticity of the eye lens.

Cylindrically ground lenses and contact lenses are provided for astigmatism (refraction impairments of the eye which are caused by irregular curvature, generally of the cornea, and which are generally considerable and congenital), and compensate for asymmetry of the eye, and thus for the astigmatism. Finally, the spectacle lenses are ground as prisms for convergence impairments.

It is often necessary to grind lenses in a combination of the forms mentioned above, in order to simultaneously correct for a number of anomalies. The focal length of the entire eye system is in this case increased or decreased such that (parallel) rays coming from objects at long distances produce a sharp image on the retina when the eye is at rest. The strength (refractive power) of the lenses is measured by the reciprocal of the focal length in meters, and this is referred to as diopters (abbreviation dpt, previously dptr). A lens with a focal length of 1 m thus has a refractive power of 1 dpt=1 m⁻¹.

Convergent lenses are denoted by +, and divergent lenses by −; for example, a +2 dpt lens is a convergent lens with a focal length of 50 cm (for hypermetropia), while a divergent lens of −2 dpt has a focal length of 50 cm (for myopia).

In the case of bifocal glasses (lenses with two focal points), the upper part is ground for long-distance vision, and the lower for near vision, so that the person wearing the spectacles just has to look downwards, in order, for example, to be able to read, and upwards in order to clearly see objects at long distances. Trifocal lenses are bifocal lenses in whose center a further lens has been ground for medium distances. Apart from being mounted in spectacle frames, lenses for the eye are mounted in clips (pince-nez) or lorgnettes or monocles; contact lenses (thin glass shells) are fitted directly to the cornea, under the eyelids, such that they cannot be seen.

Cameras (in general any photographic recording device) have been known for a long time as well. Modern cameras comprise four basic components: a housing, a shutter, an aperture and an objective. The film is located in the lightproof housing, together with the aperture and the shutter. The objective, which is fitted at the front of the camera, is formed from a number of optical glass lenses. This makes it possible for the photographer to focus on his subject such that a sharp image is projected on the film. The aperture, which is generally variable, and the shutter together regulate the incidence of light. Variable apertures are composed of metal or plastic irises, which ensure a variable, circular opening. The various aperture sizes correspond to f-factors, which are stated on the camera or on the objective. Low f-factors denote a wide aperture opening, and high f-factors denote a small aperture opening.

The shutter in the beam path of the camera controls the period for which light is incident (exposure time) by opening and closing. Most modern cameras have a focal-plane shutter or an iris aperture and a viewfinder system which makes it possible for the photographer to choose the image detail exactly. All single-lens mirror reflex cameras are equipped with this apparatus. Furthermore, virtually all cameras are equipped with a focusing unit and a film transport mechanism.

In order to achieve a greater light level, modern cameras have lenses whose use admittedly results in imaging errors, which must be compensated for by complicated lens systems. The most important imaging errors are: chromatic distortion, spherical aberration, coma and distortion and astigmatism and field curvature. The distortion is barrel-shaped if the aperture is arranged in front of the objective, or cushion-shaped if it is arranged behind the objective; these imaging errors occur even when using auxiliary lenses.

The amount of incident light required for the optimum film exposure is controlled by the exposure time (shutter time) and the aperture opening, which have a proportional relationship between them. The shorter the shutter time, the larger the aperture must be for the same amount of light to reach the film. Shorter shutter times (and hence wider aperture openings) are chosen in order to freeze the movement of subjects. Conversely, a small aperture opening (and a correspondingly longer exposure time) can be used to increase what is referred to as the depth of focus. The depth of focus describes that physical area within which the objects which are recorded in a photograph are reproduced clearly. In photographs with a large depth of focus, for example, both near objects and objects at long distances can be identified with accurate detail. Many cameras have a scale on the objective, to indicate the depth of focus of different aperture settings.

A wide range of camera models are available for different purposes. A distinction is drawn on the basis of the film formats for large format cameras (9×12 to 24×30 cm), medium format cameras (6×9, 6×7, 6×6, 6×4.5 cm), small image cameras (24×36, 18×24 mm), and miniature image cameras (10×14 and 13×17 mm); screen focusing cameras, viewfinder cameras and mirror reflex cameras also exist. Cameras with viewfinder rangefinders are equipped with direct-vision optical viewfinders (with integrated rangefinder), which allow the photographer to choose the image detail. The viewfinder does not, however, point exactly at the image detail as seen by the objective, but only at an approximately identical image. If the image as seen by the objective does not match the image shown in the viewfinder, this is referred to as parallax. This discrepancy is virtually irrelevant for subjects at long distances. However, at short distances, parallax can lead to a subject not appearing completely on the final photograph.

Single-lens and two-lens mirror reflex cameras are equipped with mirrors which pass the subject as seen by the objective to the viewfinder. Two-lens mirror reflex cameras have a viewfinder which comprises a horizontal viewing screen fitted at the top of the housing. The lower of the two objectives on the front of the camera is used to expose the film, and the upper for viewing the subject. The two objectives are connected to one another, so that focusing of the one objective automatically also results in focusing of the other. An image as seen by the viewfinder objective is projected onto the viewing screen via a mirror that is fitted at an angle of 45°. During the focusing process, the photographer looks at the desired image detail. The image as seen by the lower objective is passed to the film that is located in front of the rear face of the housing. Parallax also occurs in the case of two-lens mirror reflex cameras, in the same way as with viewfinder cameras.

With single-lens mirror reflex cameras (SLRs), the objective is used both for looking at the image detail and for exposing the film. The image of the subject is passed in mirror-image form via an obliquely positioned mirror and through a pentagonal prism to the viewfinder. When the shutter mechanism is operated, that is to say the shutter is opened, the mirror is folded up, so that the incident light can expose the film without any impediment. Single-lens mirror reflex cameras are not subject to any parallax.

Most single-lens mirror reflex cameras have an (electronic) focal-plane shutter. Many are equipped with automatic exposure control. The aperture setting often allows electronic or manual control. More and more camera manufacturers are producing SLR cameras with autofocusing, in which the distance to the subject is calculated automatically. The electronic functions of many cameras are also coordinated by central processing units. Most autofocus cameras use infrared light or ultrasound for rangefinding and for focus control (active autofocus). Others are equipped with a passive autofocus system, in which the focal length of the camera is varied until the two images perceived by the camera are made to coincide.

The major advantage of single-lens mirror reflex cameras is that the image which appears in the viewfinder is actually identical to the image which is later burnt onto the film. Furthermore, single-lens mirror reflex cameras can be operated relatively easily. A wide range of alternate objectives and camera accessories are also commercially available. Because of this, SLRs are loved equally by professional and amateur photographers. Cameras with viewfinder rangefinders, which were used in the past by photographic journalists owing to their compactness and simplicity of handling, have been largely replaced by single-lens mirror reflex cameras. Owing to their simpler optical system, the former are, however, more robust, lighter and quieter than the latter. In comparison to the other two camera types, the handling of two-lens mirror reflex cameras is more complex. Furthermore, only a small range of alternate objectives are available. However, owing to the larger negative format, it is possible to produce photographs with greater detail clarity: because of this, for example, the US astronauts on the Apollo mission used a two-lens Hasselblad mirror reflex camera to take photographs on the moon. In addition to these camera types, there are also small image compact cameras, which are extremely popular with amateur photographers and whose operation has now been largely automated.

With regard to photographic objects, a distinction is drawn between wide-angle, normal and telephoto objectives. These terms relate to the focal length of the objective, which is stated in millimeters. The focal length describes the distance between the focal point and the objective lens. The focal length of the objective governs the image detail and the depth of focus in the photograph.

Large format cameras, cameras with rangefinder viewfinders, and mirror reflex cameras are equipped for all three objective types. A standard objective, which cannot be interchanged and has a focal length of 20 to 35 millimeters, is generally used for small image cameras. This wide-angle objective offers the greatest depth of focus, and also covers a wider image area than other objectives. In consequence, subjects that are focused on at long distance appear to be extremely small. Extreme wide-angle or fisheye objectives offer a viewing angle of 180° or more. In consequence, the image as projected onto the film is subject to circular distortion. Objectives with focal lengths of 45 to 55 millimeters are referred to as normal objectives, since they make it possible to take photographs which are most similar to the imaging scale and perspective of the image as seen by the human eye. Objectives with longer focal lengths are referred to as telephoto objectives. These offer a limited field of view and little depth of focus, but show the image area enlarged. For small image cameras, objectives with focal lengths of 85 millimeters or more are referred to as telephoto objectives.

The capabilities for automation have been perfected with the aid of microchips and optoelectronic components. For example, autofocus cameras allow automatic range adjustment by means of zoom objectives. Zoom objectives are variable objectives (referred to in the past as rubber lenses), that is to say objectives with a variable focal length, which allow the imaging scale to be varied continuously without changing position. With a real zoom objective, there is no need to adjust the focus when the focal length is varied. Zoom objectives for small image cameras have 10 to 20 lenses. The imaging performance, which was initially poor, has now been considerably improved, but objectives with fixed focal lengths allow more light to enter and are sharper in the extreme area. Zoom objectives are particularly suitable for combination with single-lens mirror reflex cameras, since changes in the focal length (and hence in the subject size) can be seen in the viewfinder.

Plastic or glass filters which are fitted to the camera objective are used, inter alia, to change the color, the contrast or the brightness. They can also be used to achieve special effects.

The limits between classical photography and other image recording systems are now starting to become blurred. For example, electronic information media are being increasingly used instead of silver halogen emulsions for still photographs. The photograph resolution (493×373 and 320×240 pixels) corresponds to the image quality of conventional PC monitors; a memory with the size of 1 Megabyte is sufficient for eight to 16 images. The special Picture Postcard Software is required if one wishes to send these via the Internet. Video still cameras (digital cameras) are available for this purpose, which record the image data—different light levels reflected from the objects being photographed—on a floppy disk. The complete image can then be viewed on a conventional television screen, with a paper copy being produced on a printer. CCD camera modules or CMOS camera modules are also known in a miniature format for monitoring purposes in the field of industry, for security and safety purposes, and for video telecommunication etc. By way of example, a CCD mini finger camera is known having a housing with a length of 55 mm and a diameter of 18 mm as well as a 14 mm lens diameter, a light sensitivity of 0.5 lux, a focal length of 3.6 mm and automatic shutter adjustment, as well as a weight of 27 g, as is a CCD miniature camera module with a length and width of 32 mm and a depth of 14 mm, a light sensitivity of 2 lux, a focal length of 4.5 mm, automatic shutter adjustment and a weight of 10 g. Compared to this, a CMOS camera module is known with a length and width of 16 mm as well as a depth of 15 mm, a focal length of 4.9 mm and an aperture of 2.8 mm.

Combinations are also known as vision aids. By way of example, DE 34 18 319 C1 discloses a vision aid with a video monitor, a video camera, a base (which can be moved into the field of view of the video camera) for the item to be read, and an apparatus for producing relative movement between the objective of the video camera and the base. In detail, provision is made for a scanning mirror to be held—by means of a joint which can be rotated about two mutually perpendicular axes—in the beam path of the objective of the video camera. A drive motor is coupled to the mirror for each rotation axis. Finally, an operating apparatus is provided which can be operated by hand or by foot, and whose control signals are passed to the drive motors via an electronic control apparatus.

Furthermore, DE 84 37 9921 U1 discloses a vision aid, in particular a reading aid, having a supporting frame for two optical lenses which are arranged at a distance from one another. The frame has a central supporting part, on which a user is intended to rest the bridge of his or her nose, at least one holding element, which is connected to this central supporting part, for holding the two lenses, and two side pieces, which are attached to the free ends of the frame such that they can pivot and are intended to rest on the ear flap attachments. In detail, provision is made for the two optical lenses to be attached to the holding element or to the holding elements of the supporting frame such that they can be detached and can be interchanged by the user of the vision aid while the holding element or the holding elements is or are firmly connected to the central supporting part.

DE 298 04 368 U1 discloses spectacles with a manually adjustable focusing device. The focusing device contains an additional frame, which comprises two lens frames, as well as two annular wheels, which are arranged in these lens frames such that they can rotate. Furthermore, a flexible revolving device which connects the two wheels, and two lenses which are fitted into the two annular wheels, are provided. A gripping plate is arranged firmly on an intermediate piece on one inner face of the additional frame, and is provided with a tab. The main frame has two side pieces, which are pushed over the ears of a user, and two lens frames, into which two lenses are inserted. The main frame also has, on its inner face, a recess which is designed such that it can hold the tab on the gripping plate.

The optical device according to DE 37 20 190 A1, for use by people who are suffering from major visual weaknesses, has a similar design. This optical device has a conventional spectacle frame, which is equipped with neutral or optical lenses, with a telescope lens system being fitted in front of these lenses and being focused at a common focal point at a predetermined distance away from the spectacle frame. In detail, provision is made for a further frame, to which one or two prismatic lenses are fitted, to be fitted in a hinged manner on the spectacle frame. Furthermore, a lever is provided for moving the same in front of the or each telescope system, so that this allows the focal length of the entire system to be changed to a variable focal length. The lever is also used for removal of the lenses which have been mentioned, from this position, out of the optical path.

DE 199 59 379 A1 discloses spectacles with a variable refractive power. These spectacles have vision optics, in which the refractive power, the positions and the directions of the optical axes can be varied. Finally, an adjusting device is provided for simultaneous adjustment of the refractive power, of the position and of the direction of the optical axis of the respective vision optics.

The spectacles disclosed in DE 299 11 082 U1 are designed in a similar manner, with eleven small openings being provided to increase the visual power, which can be set to any desired visual power by adjustment facilities which can be rotated.

Furthermore, DE 40 04 248 C1 discloses a binocular vision aid, having a frame which can be fitted to the head of the user, two optical systems which are supported by the frame such that the optical axis of each optical system runs through an assumed center of rotation of the eye of the user that is associated with that optical system, so that the user can simultaneously use each of his two eyes to look through the optical system which is associated with the respective eye. Furthermore, angle adjusting means are provided in order to set the direction of the optical axes of the two optical systems in the plane which contains the optical axes for in each case one of at least two different working distances. The angle adjusting means have guides such that, when each of the optical systems is moved in its guide, the associated optical axis is rotated about the assumed center of rotation of the associated eye of the user. Finally, correction means are provided, in order to allow the optical systems to be focused at the respective working distance.

Spectacles with a light intensity adjustment are also known. For example, DE 93 13 834 U1 discloses spectacles which have a first pair of lens mounting grooves and a second pair of lens mounting grooves in two mountings in the spectacle frame. A first pair of lenses and a second pair of lenses are fitted respectively into the first and second pair of lens mounting grooves, with the first and second pairs of lenses being in the form of polarization filters. The second pair of lenses has teeth around the circumference. Two transmission gearwheels are fitted in the center of the frame, and engage with the teeth on the second pair of lenses. A drive mechanism is also provided to allow the transmission gearwheels to be rotated, so that the second pair of lenses is rotated with respect to the first pair of lenses.

Furthermore, electronic spectacles are also known. For example, DE 197 24 139 C1 discloses electronic spectacles having a spectacle frame which has at least one electronic camera and two displays, which can each be viewed in binocular form by the user, through viewing optics. Furthermore, image processing electronics are provided, which process the image recorded by the electronic camera and produce an output signal for driving the displays. In detail, at least one of the two viewing optics contains a wedge-shaped lens, which is bounded by two opposite planar surfaces with an angle between them, and which is mounted such that it can be rotated about an axis which runs approximately at right angles to one of the two planar surfaces, and approximately parallel to the optical axis of the viewing optics.

Spectacles with a variable refractive power, whose refractive power can be adjusted in order to assist the accommodation of the eye, are disclosed in DE 199 59 379 A1. These spectacles have two vision optics, which each have a lens with variable refractive power, and a variable-angle prism. Furthermore, a first adjusting mechanism is provided for adjusting the refractive power of the lenses with variable refractive power, and a second adjusting mechanism is provided for adjusting the prismatic refractive power of the variable-angle prisms, and a connecting mechanism is also provided. The first adjusting mechanism varies the curvature of the front surface of the respective lens, in order to vary its refractive power. The second adjusting mechanism varies the inclination angle of the front surface of the respective variable-angle prism, in order to vary its prismatic refractive power. Finally, the connecting mechanism associates the settings of the first and second adjusting mechanism with one another, in order to link the two settings to one another. This allows convenient binocular vision even when the spectacles are worn for a long time, and the equilibrium between accommodation and vergency is not disturbed. In detail, the lenses with variable refractive power have a flexible sleeve, which is filled with a transparent liquid.

In detail, each variable-angle prism comprises two fixed transparent platelets and a flexible membrane, which seals the space between the fixed transparent platelets. The internal area is filled with transparent liquid. The front surface of each prism with variable refractive power is inclined, in order to vary the edge angle externally on the side of the incline of a mount, corresponding to the volume of the transparent liquid. A first pump is provided in order to adjust the volume of transparent liquid which is forced into the lens with variable refractive power. The first pump and an electromagnet which drives a piston in the first pump form a first adjusting mechanism for adjusting the refractive power of the lens. A second pump for adjusting the volume of transparent liquid which is forced into the variable-angle prism is connected to it. The second pump and an electromagnet which drives a piston in the second pump 3Ra form a second adjusting mechanism for adjusting the prismatic refractive power of the prism. In a similar way, a third pump which is connected to the lens with variable refractive power and an electromagnet form the first adjusting mechanism. A fourth pump, which is connected to the variable-angle prism, and an electromagnet form the second adjusting mechanism.

The spectacles with variable refractive power according to DE 199 59 379 A1 also have a distance sensor for measuring the distance to an object, a processor for controlling the four electromagnets and a memory in which the relationship between the distance to an object and the required drive level for the electric magnets is stored. The processor reads the drive level for the electromagnets from the memory on the basis of a signal for the distance to the object from the distance sensor, and then controls the electromagnets in order to adjust the refractive power of the lenses with variable refractive power. At the same time, the processor reads from the memory the drive level (which corresponds to the signal for the distance to the object) for the electromagnets corresponding to the additional refractive power, and controls the electromagnets in order to adjust the prismatic refractive power of the variable-angle prisms. In this case, the processor acts as a connecting mechanism for associating the adjustment with the first adjusting mechanism to the adjustment with the second adjusting mechanism, in order in this way to link the one setting to the other setting. With this design, when the distance to the object changes, both the refractive power and the prismatic refractive power change, thus maintaining the equilibrium between the accommodation and the vergency.

JP 08-043 775 A discloses similar electronic spectacles with a microcomputer, a rangefinder and autofocus. In this case, a +18 D lens and a −20 D lens are provided, thus providing an adjustment range between 5 m and 30 cm. The rangefinder is installed in the central web of the spectacles.

Video recording apparatus which can be worn by the user like spectacles is disclosed in DE 3342126-A1. When recording, the scene is recorded by the user using a miniature television camera, which is mounted on the spectacle frame (or using two cameras if the recording is intended to be used for three-dimensional viewing). The miniature camera or cameras can be concealed within the spectacle frame and make it possible for the user to see the scene normally and also to check by means of a viewfinder, which indicates the part of the scene which is available for the television camera. This makes it possible for the user to take photographs while his or her hands are free, and ensures that a scene is recorded virtually instantaneously, since looking at the scene results in the camera and the viewfinder being pointed in the direction of that section of the scene which is intended to be recorded. Since different people's eyes have different distances from one another, the field of view should be set such that it matches the user. In general, it is quite expedient to set the position of the viewfinder on the lens and adjust it up and down as a receptor within the camera. The viewfinder can be moved horizontally or up and down, and the movement can be adjusted by means of the nose pads on the spectacles. If a zoom facility is required, this could be achieved electronically, with each individual camera having a CCD chip which can record light and can produce an electronic signal as a function of the image which is received by the optical charge coupling element. The chip is fitted behind a single lens element, typically a 16 mm F2 wide-angle lens, and a mirror. The camera unit does not need to have focal length adjustment, provided that an optical lens with a short focal length is used. Focal length adjustment could be provided if required, in which case a simple focal length thread could be used to adjust the lens. If it is desirable for the adjustment by the focal length thread to be concealed, a small sliding lever could be attached to the rear face of the frame. A focal length indicator could also be provided, for example with a color code, and could be inserted along the CCD in such a manner that it is visible only to the user. Alternatively, automatic focusing can also be carried out electronically or by other means.

As described above, the aperture could be controlled by hand or by means of a simple electronic process, such as a liquid crystal device immediately behind the camera lens. Alternatively, a CCD with an adequate light acceptance band could be chosen so that the aperture function could be achieved by means of an automatic gain control circuit in the recording apparatus. The video recording apparatus, in particular the fitting of an electronic lens and of an image viewfinder on lenses, protective goggles or other spectacles according to DE 3342126 A1, has a wide field of application. Conventional recording of a video tape or of electronic still images can be carried out with a minimum amount of effort and without any hindrance to the hands. This allows the camera to be handled when skiing, driving, flying, etc. There are other applications in the creation of do-it-yourself video training tapes, in the field of industry, in the creation of training films and, in the production of recording which is available immediately, as a camera for the disabled, and in the security and military fields, where secrecy is sometimes desirable.

Finally, DE 196 24184 A1 discloses sunglasses or spectacles with a hearing aid, with a receiving device for messages, preferably broadcast radio transmissions. A volume control, a combination switch and a program selector wheel are arranged in different slots in the area of the installed receiver in the upper part of the side piece. An earpiece with a tubular clip (which is mounted on a linear movement apparatus for adjustment purposes) can be seen in a further slot in the rear ear section. This comprises a sliding part which can be moved to different latched positions in a sliding bearing with catch stops. In this case, a microphone is also provided behind a microphone opening, and can be switched on as required via the combination switch. A rechargeable battery is also installed in an installation area which is provided with a cover. The individual appliance units in the two side pieces are connected to one another via connecting lines that are located in the bridge. Sliding ring contacts or else bridging lines may be arranged on the joints for this purpose. The combination switch allows the receiver to be switched on and off in two positions, and allows the microphones to be switched on in another position. Mountings for the connection of a cassette recorder or the like are located underneath the side piece.

As the above appraisal of the prior art indicates, binocular optical apparatuses, electronic spectacles and vision aids are known for various fields of application. The major disadvantage of the optical apparatuses described above is that the focusing of the optical systems at the respective working distance involves a considerable amount of mechanical complexity and continuous manual efforts, and they are generally relatively heavy. Electronic spectacles with micro-computers, rangefinders and autofocus cannot satisfy all of the different requirements in a cost-effective manner either, since they represent a costly special solution to match the requirements. Electronic spectacles are therefore not widely used and, in general, adapted spectacles or a vision aid are or is produced for each individual user after an appropriate eyesight test. This is particularly important because the industry working in the optical field can be regarded as an extremely progressive industry, which welcomes developments, acts on improvements and simplifications very easily, and implements them in practice.

In contrast to the known binocular optical apparatuses, the invention is based on the object of designing such apparatuses at low cost, in such a way that automatic focusing can be achieved, including correction for various visual impairments.

This object is achieved by a binocular optical apparatus, in particular electronic spectacles, as claimed in patent claim 1, in that this apparatus has:

A spectacle frame,

At least one electronic camera which is mounted on the spectacle frame, and

a lens system, which can be moved by a motor, is arranged at the front and is connected to the electronic camera,

such that visual impairments are corrected by adjusting the refractive power of the lenses and/or focusing, including automatic adjustment to the reading distance or working distance.

The optical apparatus according to the invention has the advantage that continuous individual correction for visual impairments can be carried out in a surprisingly simple manner. The additional weight of the electronic camera modified according to the invention, preferably a video camera whose lens points forwards, is not significant in terms of the overall weight of the optical apparatus, since a saving in weight is achieved by dispensing with a manual adjusting apparatus for focusing. The invention is in this case based on the fusion according to the invention of a camera function and a spectacle function in order to satisfy the individual requirements of the wearer. This for the first time provides largely fully automatic spectacles for daily use, based largely on the use of electronic control, which allows various requirements to be satisfied with high precision without having to accept a high degree of complexity to do so. The broad field of application extends from people with severe visual impairments to vision aids for surgeons and for the installation of micromechanical systems in industry, etc. The physical depth of the frame is preferably between 28 mm and 50 mm, and the magnification range is preferably between 2.5 and 10 times. In practice, it has been found that the maximum total weight is about 70 grams. The absence of manual adjustment, as present for example in the case of the spectacles with the manually adjustable focusing device according to DE 298 04 368 U1, results in the spectacles being convenient to handle, and also allows those with severe visual impairments to move safely.

In one preferred refinement to the invention, as claimed in patent claim 2, an electronical control device is provided, which is connected to the lens system and to the camera and has a memory for storing the manual preset values for both eyes as nominal values for adaptation for automatic correction for the eye separation and visual impairment during operation.

This refinement of the invention has the advantage that the effort for fully automatic adjustment can be kept low by means of a single, individual initial adjustment. A really clear image is achieved all the time by the continuous, contrast-controlled automatic focusing.

In a development of the invention, as claimed in patent claim 3, the control device is used for motor control, and a transmission is arranged on the output drive side of the motor in order to increase the rate of adjustment.

This development of the invention has the advantage that the focusing can be changed from 25 cm to infinity in about 0.2 seconds to a maximum of one second, by means of direct motor control and the transmission.

Preferably, as claimed in patent claim 4, the lens system is made of plastic, and guide means are also provided for adjustment by bending and/or rotation of the individual lenses.

Guide means for rotating individual lenses allow high-precision mounting and ensure very low friction losses and a very low-wear method of operation. The lens system can also be refined to have two or more switchable focal lengths, in particular in the form of a birefringent crystal such as that in the lens system according to DE 90 16 891 U1, or the lenses can be adjusted by tilting them about axes which are at right angles to the optical axis, as is described in detail for the apparatus in DE 199 05 779 A1. The lens system may also have a multi-faceted lens with at least four optical surfaces, of which two surfaces can in each case be introduced in pairs into the beam path of the lens system by means of a rotating device for adjustment of the desired focal length of the lens system; see, for example, the lens system according to DE 196 03 191 C2, which is intended for cameras, video cameras, telescopes or the like. It is also possible—with appropriate adaptation—to use zoom objectives which are used for cameras, such as those which are described for a camera with a motor-driven zoom objective tube in DE 41 04 548 C2 or for a camera with a motor-driven variable objective in DE 43 12 489 A1, or for an objective tube which is operated manually and by means of an electric motor in DE 100 09 684 A1.

In a development of the invention, as claimed in patent claim 5, a wheel or tension means (belt), screw, clutch or cam transmission is provided as the transmission, and both the rigid transmission parts such as gear wheels and shafts and the deformable parts such as belts and chains, and the guide means, are made of plastic.

A transmission such as this makes it possible to provide very fine steps (stepdown ratios of single step size) and transmit high torques, without having to accept a high degree of complexity to do so. On the one hand very accurate positioning of the lens, and on the other hand a high rate of movement, can be achieved in conjunction with the control device according to the invention. It is also advantageous for all the components of the transmission and of the optical apparatus according to the invention to be made of the same material, for example plastic, and to be capable of being produced by injection molding for mass production, and for the combination to produce relatively little noise when running, to be very insensitive to manufacturing and assembly tolerances, and to be very light (a plastic lens weighs about 2 grams, while a glass lens weighs about 8 grams).

It is preferable, as claimed in patent claim 6, for a rechargeable battery to be arranged as a power supply in the spectacle frame, and an indicator for the state of charge of the rechargeable battery to be provided on the spectacle frame.

In the event of a defect, the user can use the state of charge indicator, preferably an LCD indicator, to preclude one defect cause and, furthermore, warning information can be produced that the rechargeable battery is virtually discharged (for example blinking and/or audible information as a warning tone of different volumes, or an appropriate spoken output).

One preferred refinement of the invention, as claimed in patent claim 7, provides for use as medical spectacles or as leisure spectacles, and for an interface circuit, which is connected to the camera, to be used for the connection of recording means.

This refinement of the invention has the advantage that, in particular, tests can be recorded and an appropriate medical evaluation can be carried out. This also allows documentation to be produced in the leisure area, for example for sporting events or when walking in mountain ranges, which can be played back again later.

Preferably, as claimed in patent claim 8, a broadcast radio receiver and/or a call receiver are/is arranged in the area of the side piece and are/is connected to the indicator.

The abovementioned combination not only allows the user to be entertained and improves the leisure value of the optical apparatus, but also ensures that the user is accessible.

In a development of the invention, as claimed in patent claim 9, the frame is in the form of a dustproof closed housing, on which the side pieces are hinged and which has ventilation slots.

This development of the invention has the advantage that it allows the housing to be ventilated, thus reliably preventing the lenses being covered by sweat deposits or condensation when changing from a hot to a cold environment as can happen when entering a building.

In one preferred refinement of the invention, as claimed in patent claim 10, a removable panel is provided as an auxiliary device on the frame.

This refinement of the invention has the advantage that it allows the lenses to be cleaned and that dazzling can also be reliably avoided.

Further advantages and details can be found in the following description of preferred embodiments of the invention with reference to the drawing, in which:

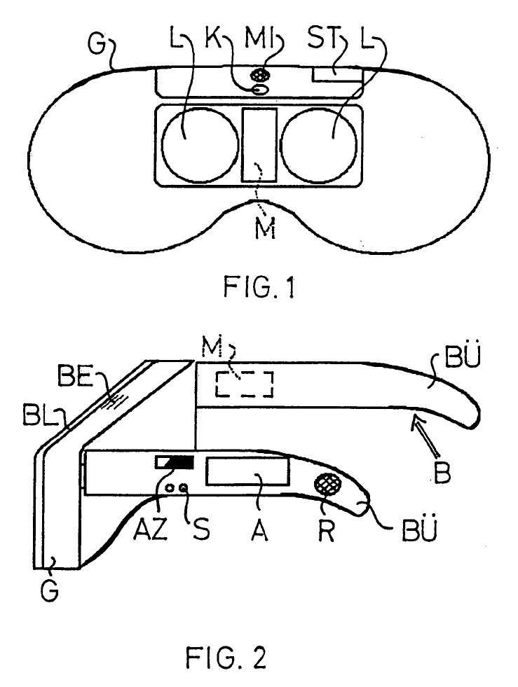

FIG. 1 shows a front view of the optical apparatus according to the invention, and

FIG. 2 shows a perspective side view.

FIG. 1 and FIG. 2 show one preferred embodiment of the optical apparatus according to the invention in the form of a fully automatic spectacle system. In principle, the concept according to the invention is suitable for many applications, for example in all vision aids which are in the form of a helmet with a visor.

The binocular optical apparatus according to the invention has a spectacle frame B which has at least one electronic camera K, preferably a video camera. A lens system L is also provided, is arranged at the front, and can preferably be adjusted by means of a motor M. The lens system L is connected to the electronic camera K such that visual impairments are corrected by adjusting the refractive power of the lenses L and/or by focusing, including automatic adjustment to the reading or working distance.

Furthermore, an electrical control device ST is provided, which is connected to the lens system L and to the camera K and has a memory for storing the manual preset values for both eyes as nominal values for adaptation for automatic correction for the eye separation and visual impairment during operation.

The control device ST is preferably used for motor control, and a transmission is arranged on the output drive side of the motor M in order to increase the rate of adjustment. A wheel or tension means (belt), or screw, clutch or cam transmission is provided as the transmission. Both the rigid transmission parts such as gear wheels and shafts and the deformable parts such as belts and chains, and the guide means, are made of plastic, for example Makralon, possibly reinforced with glass fibers.

The lens system L, preferably comprising four lenses, is made of plastic, and guide means are also provided for adjustment by bending and/or rotation of the individual lenses or of the optical axes, to point at the intended point. A design which has been found to be practical on the basis of extensive experiments has a magnification of four times for use as medical spectacles, and a magnification of 2.5 times for use as leisure spectacles (with magnification of 10 times also being within the scope of the invention, taking into account weight and cost aspects). The physical depth of the spectacle frame B is about 28 mm to 35 mm, with a magnification of 2.5 times, for the leisure spectacles, and about 35 mm to 50 mm, with a magnification of 4 times, for medical spectacles. The focusing range starts at about 2 m to 3 m for the leisure spectacles, and at 25 cm (reading distance) for the medical spectacles.

A rechargeable battery A is arranged in the spectacle frame B in order to supply power to the camera K, the control device ST and the motor M. An indicator AZ for the state of charge of the rechargeable battery A is also provided on the spectacle frame B.

A broadcast radio receiver R and/or a call receiver can be arranged in the area of the side pieces BÜ, and is or are connected to the indicator A. Furthermore, an interface circuit S, which is connected to the camera K, can be provided for connection of recording means.

The frame is in the form of a dustproof, closed housing G, on which the side pieces BU are hinged. The mechanism as well as the lenses L, the diopter setting, the focusing and the control device for focusing, as well as a frame to hold all the components in a position appropriate to the function, are accommodated in the housing G, which may also have ventilation slots BE.

Finally, a removable panel BL is provided as an auxiliary device on the frame, and a microphone M1 can be arranged at the front. The panel may be made of fracture-resistance cellulose acetate, and is interchangeable or can be replaced.

In comparison to the known prior art, the optical apparatus according to the invention does not require continuous manual gain adjustment, and visual impairments can be largely corrected with surprisingly little complexity, since the adjustment process is carried out all the time by the contrast-controlled automatic focusing.

All the illustrated and described embodiment options, as well as all the novel individual features which are disclosed in the description and/or in the drawing and in combination with one another, are significant to the invention. For example, a focusing lens group can be moved along the optical axis for focusing purposes by rotating an operating element (guide means), or a variator lens group and compensator lens group can be provided which can be moved relative to one another along the optical axis by axial movement of the operating element in order to change the focal length, the mountings and the spectacle frame can be made largely of Makralon (possibly reinforced with glass fibers), the video camera may also have a CCD sensor in addition to the objective, with these components being arranged together with the other electronics on a printed circuit, an additional mounting can be provided for the connection of an external rechargeable battery, and the adjustment process, in particular the initial adjustment, can also be carried out by means of remote control and an associated remote control receiver, etc.

1. A binocular optical apparatus, in particular electronic spectacles,
having a spectacle frame (B),
having at least one electronic camera (K) which is fitted to the spectacle frame (B), and
having a lens system (L), which can be moved by a motor (M), is arranged at the front and is connected to the electronic camera (K),
such that visual impairments are corrected by adjusting the refractive power of the lenses and/or focusing, including automatic adjustment to the reading distance or working distance.

2. The optical apparatus as claimed in claim 1, characterized in that an electrical control device (ST) is provided, which is connected to the lens system (L) and to the camera (K) and has a memory for storing the manual preset values for both eyes as nominal values for adaptation for automatic correction for the eye separation and visual impairment during operation.

3. The optical apparatus as claimed in claim 1, characterized in that the control device (ST) is used for motor control, and in that a transmission is arranged on the output drive side of the motor (M) in order to increase the rate of adjustment.

4. The optical apparatus as claimed in claim 1, characterized in that the lens system (L) is made of plastic, and in that guide means are provided for adjustment by bending and/or rotation of the individual lenses.

5. The optical apparatus as claimed in claims 3 and 4, characterized in that a wheel or tension means (belt), or screw, clutch or cam transmission is provided as the transmission, and in that both the rigid transmission parts such as gear wheels and shafts as well as the deformable parts such as belts and chains, and the guide means, are made of plastic.

6. The optical apparatus as claimed in claim 1, characterized in that a rechargeable battery (A) is arranged as a power supply in the spectacle frame (B), and in that an indicator (AZ) for the state of charge of the rechargeable battery (A) is provided on the spectacle frame (B).

7. The optical apparatus as claimed in one or more of claims 1 to 6, characterized by use as medical spectacles or as leisure spectacles with different magnification with respect to one another, with an interface circuit (S), which is connected to the camera (K), being provided for the connection of recording means.

8. The optical apparatus as claimed in claim 6 or 7, characterized in that a broadcast radio receiver (R) and/or a call receiver are/is arranged in the area of the side piece (BO) and are connected to the indicator (AZ).

9. The optical apparatus as claimed in one or more of claims 1 to 8, characterized in that the frame is in the form of a dustproof closed housing (G), on which the side pieces (BO) are hinged and which has ventilation slots (BE).

10. The optical apparatus as claimed in one or more of claims 1 to 9, characterized in that a removable panel (BL) is provided as an auxiliary device on the frame.
